(19) United States
(12) Patent Application Publication
(10) Pub. No.: US 2024/0209151 A1
(43) Pub. Date: Jun. 27, 2024

(54) BIMOLECULAR BLOCK POLYMER AND ELECTROLYTE AND ELECTRICAL DOUBLE LAYER CAPACITOR CONTAINING THE SAME

(71) Applicant: Industrial Technology Research Institute, Hsinchu (TW)

(72) Inventors: Yueh-Wei Lin, Hsinchu County (TW); Chia-Chen Fang, Taipei City (TW); Chun-Lung Li, Taoyuan City (TW); Kun-Ping Huang, Miaoli County (TW)

(73) Assignee: Industrial Technology Research Institute, Hsinchu (TW)

(21) Appl. No.: 18/190,071

(22) Filed: Mar. 25, 2023

(30) Foreign Application Priority Data
Dec. 20, 2022 (TW) 111148832

(51) Int. Cl. C08G 73/08; C08G 81/00; H01G 11/62; H01G 11/64

(52) U.S. Cl. CPC C08G 73/08; C08G 81/00; H01G 11/62; H01G 11/64; H01G 11/60

(57) ABSTRACT

Provided are a bimolecular block polymer and an electrolyte and an electrical double layer capacitor containing the same. The bimolecular block polymer is suitable for an electrolyte of a capacitor, and is formed by polymerizing a first compound and a second compound. The first compound is represented by one of formula (A-1) to formula (A-4). The second compound is represented by one of formula (B-1) to formula (B-5). A molar ratio of the first compound to the second compound is between 5:1 and 1:5.

### CROSS-REFERENCE TO RELATED APPLICATION

This application claims the priority benefit of Taiwan application serial no. 111148832, filed on Dec. 20, 2022. The entirety of the above-mentioned patent application is hereby incorporated by reference herein and made a part of this specification.

### TECHNICAL FIELD

The present disclosure relates to a polymer and an electrolyte and a capacitor containing the same, and particularly relates to a bimolecular block polymer and an electrolyte and an electrical double layer capacitor containing the same.

### BACKGROUND

An electrical double layer capacitor is a charge storage device, which capacitor may also be called a supercapacitor (SC). The electrical double layer capacitor may store charge through electrostatic forces at the interface between the electrodes and the electrolyte. Since electrical double layer capacitor stores and releases energy through the electrical double layer structure formed by adsorption of the electrostatic charge, there is almost no loss of electrolyte and electrodes incurred during the repeated charging and discharging process. Thus, the electrical double layer capacitor may have excellent reversible capacity, long-term charge-discharge capacitance retention rate, and cycle life that reaches tens of thousands of cycles.

### SUMMARY

The bimolecular block polymer of the present disclosure is suitable for an electrolyte of a capacitor, and is formed by polymerizing a first compound and a second compound. The first compound is represented by one of formula (A-1) to formula (A-4). The second compound is represented by one of formula (B-1) to formula (B-5). A molar ratio of the first compound to the second compound is between 5:1 and 1:5.

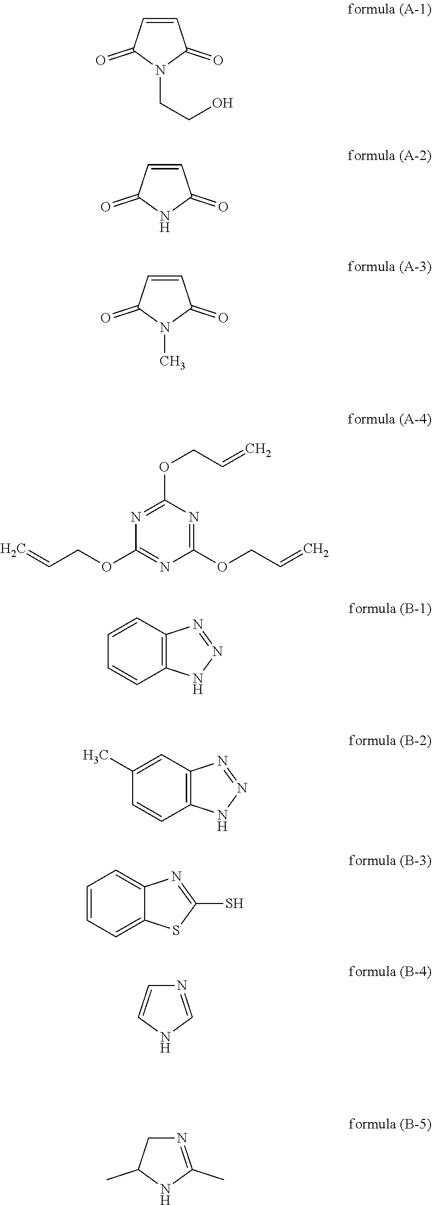

The electrolyte of the present disclosure is suitable for a capacitor and includes a quaternary ammonium salt, a bimolecular block polymer and a residual amount of an organic solvent. Based on the total weight of the electrolyte, the content of the quaternary ammonium salt is between 0.5 M and 2.0 M, and the content of the bimolecular block polymer is between 0.01 wt % and 5 wt %. The bimolecular block polymer is formed by polymerizing a first compound and a second compound. The first compound is represented by one of formula (A-1) to formula (A-4). The second compound is represented by one of formula (B-1) to formula (B-5). A molar ratio of the first compound to the second compound is between 5:1 and 1:5.

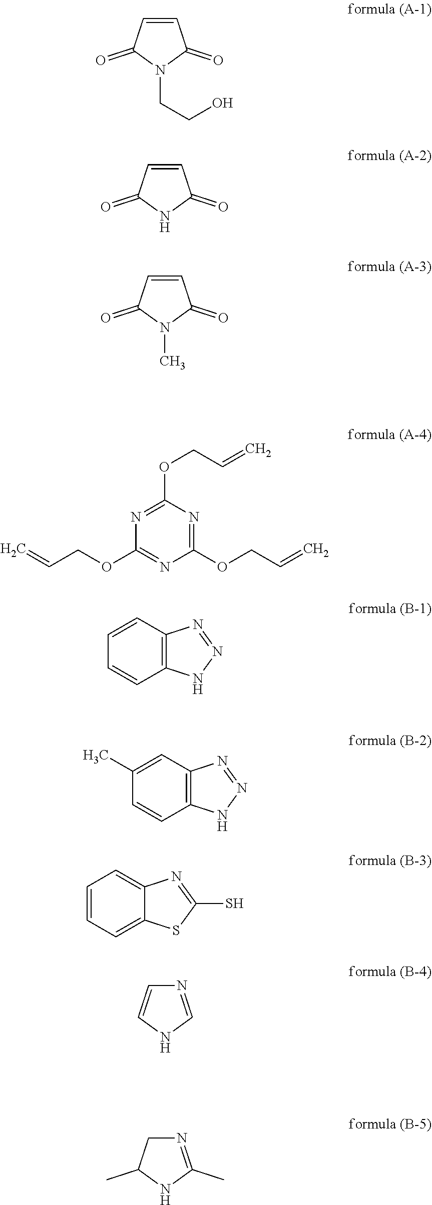

The electrical double layer capacitor of the present disclosure includes an anode and a cathode disposed opposite to each other, a separator disposed between the anode and the cathode, and the electrolyte.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a gel permeation chromatography (GPC) diagram of the bimolecular block polymer in a Synthesis Example.

FIGS. 2 to 21 are the current-voltage (C-V) curves obtained by performing the durability test on the capacitors of the Experimental Examples and the Comparative Examples, respectively.

### DESCRIPTION OF THE DISCLOSURE EMBODIMENTS

The embodiments are described in detail below with reference to the accompanying drawings, but the embodiments are not intended to limit the scope of the present disclosure. In addition, the drawings are for illustrative purposes only and are not drawn to the original dimensions. For ease of understanding, the same elements in the following description will be denoted by the same reference numerals.

The terms mentioned in the text, such as “comprising”, “including” and “having” are all open-ended terms, i.e., meaning “including but not limited to”.

When using terms such as “first” or “second” to describe a device, it is only used to distinguish these devices from each other, and does not limit the order or importance of these devices. Therefore, in some cases, the first device can also be called the second device, and the second device can also be called the first device, and such expression does not deviate the content from the scope of the present disclosure.

In addition, in the text, the range indicated by “between a value and another value” is a general expression to avoid listing all the values in the range one by one in the specification. Therefore, the description of a specific numerical range covers any numerical value within the numerical range, as well as a smaller numerical range defined by any numerical value within that numerical range.

In the present disclosure, the bimolecular block polymer is formed by polymerizing a specific first compound and a specific second compound, which will be described in detail later. Therefore, when the electrolyte of a capacitor includes the bimolecular block polymer of the present disclosure, the bimolecular block polymer acts as an additive may absorb the by-products generated by the electrolyte during high-voltage degradation, thereby enabling the capacitor to exhibit a wide electrochemical stability potential window, and the cycle life of the capacitor may reach over 12,000 cycles. The capacitor is, for example, an electrical double layer capacitor.

In an embodiment of the present disclosure, the bimolecular block polymer of the present disclosure is formed by polymerizing a first compound and a second compound, and a molar ratio of the first compound to the second compound is between 5:1 and 1:5, preferably between 1:1 and 2:1.

The first compound is represented by one of formula (A-1) to formula (A-4).

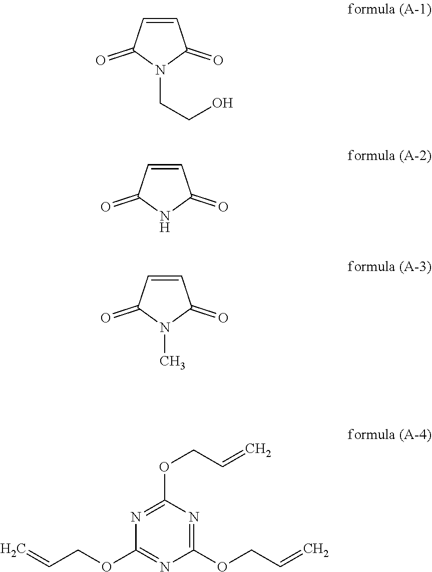

The second compound is represented by one of formula (B-1) to formula (B-5).

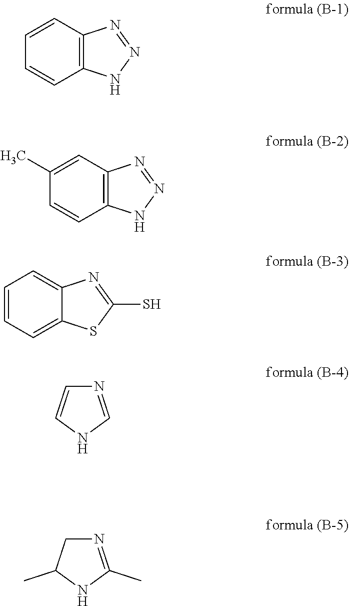

During the polymerization of the first compound and the second compound, the nucleophilic shared electron pair of the second compound may react with the molecular double bond vacant orbital of the reactive terminal functional group of the first compound, and then the polymer is formed through a free radical chain reaction. Examples are given below for explanation.

The first compound of formula (A-1) and the second compound of formula (B-1) are polymerized. The nucleophilic shared electron pair of the second compound of formula (B-1) is reacted with the molecular double bond vacant orbital of the reactive terminal functional group of the first compound of formula (A-1), and then the following bimolecular block polymer is obtained.

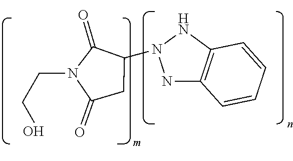 [SMILES: O=C1CC(N2Nc3ccccc3N2)C(=O)N1CCO]

Similarly, the first compound of formula (A-2) and the second compound of formula (B-3) are polymerized to obtain the following bimolecular block polymer.

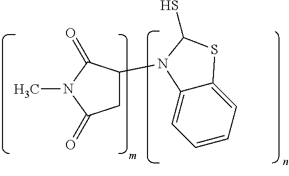 [SMILES: CN1C(=O)CC(N2c3ccccc3SC2S)C1=O]

Similarly, the first compound of formula (A-4) and the second compound of formula (B-5) are polymerized to obtain the following bimolecular block polymer.

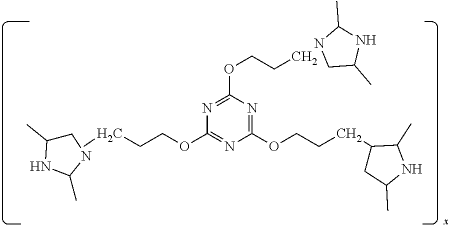

Similarly, the first compound of formula (A-4) and the second compound of formula (B-4) are polymerized to obtain the following bimolecular block polymer.

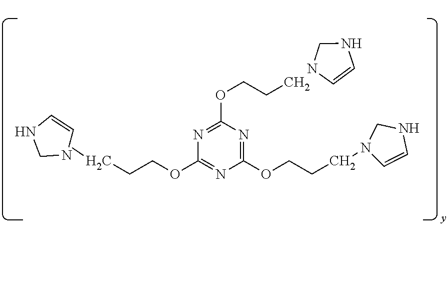

In an embodiment, after the polymerization of the first compound and the second compound, the resulting bimolecular block polymer may have reactive terminal functional groups. In addition, a molar ratio of the first compound to the second compound is between 5:1 and 1:5, and the bimolecular block polymer may have a molecular weight between 10,000 and 200,000. When the molar ratio of the first compound to the second compound is greater than 5:1, the bimolecular block polymer may have a molecular weight that is excessively large and the viscosity thereof is too high. When the molar ratio of the first compound to the second compound is less than 1:5, the first compound and the second compound can not be effectively polymerized.

The bimolecular block polymer of the present disclosure may be used as an additive for the electrolyte of a capacitor. In detail, the electrolyte may include a quaternary ammonium salt, the bimolecular block polymer of the present disclosure and a residual amount of organic solvent. In the present embodiment, based on the total weight of the electrolyte, the content of the bimolecular block polymer of the present disclosure is between 0.01 wt % and 5 wt %. When the content of the bimolecular block polymer is higher than 5 wt %, the conductivity of the electrolyte may be too low, which affects the charge efficiency. When the content of the bimolecular block polymer is less than 0.01 wt %, the by-products of the electrolyte generated during high-voltage degradation can not be effectively absorbed, and therefore the capacitor will be unable to exhibit a wide electrochemical stability window.

In addition, since the bimolecular block polymer of the present disclosure is formed by polymerizing the first compound and the second compound, and the molar ratio of the first compound and the second compound is between 5:1 to 1:5, the electrolyte will not have an excessively high viscosity, which may otherwise affect the performance of the capacitor.

In one embodiment, the first compound may be N-(2-hydroxyethyl)maleimide (formula (A-1)), maleimide (formula (A-2)), N-methylmaleimide (formula (A-3)) or triallyl cyanurate (formula (A-4)), and the second compound may be benzotriazole (formula (B-1)), 5-methyl-1H-benzotriazole (formula (B-2)), 2-mercaptobenzothiazole (formula (B-3)), imidazole (formula (B-4)) or 2,4-dimethyl-2-imidazoline (formula (B-5)).

In an embodiment, the quaternary ammonium salt may be spirodipyrrolidinium tetrafluoroborate (SBPBF4), dimethylpyrrolidinium tetrafluoroborate (DMPBF4), tetraethylammonium tetrafluoborate (TEABF4), triethylmethylammoniumtetrafluoroborate (TEMABF4) or combinations thereof. Based on the total weight of the electrolyte, the content of the quaternary ammonium salt is between 0.5 M and 2.0 M. When the content of the quaternary ammonium salt is higher than 2.0 M, the charge efficiency may be affected due to the high concentration of the quaternary ammonium salt. When the content of the quaternary ammonium salt is lower than 0.5 M, the charge efficiency may also be affected due to the low concentration of the quaternary ammonium salt. When the quaternary ammonium salt is dissolved in an organic solvent, the cation of the ammonium salt with a low-degree-of-freedom substituent structure will not decompose easily under the applied potential. As a result, the above-mentioned quaternary ammonium salt is particularly suitable as a component of the electrolyte of the electrical double layer capacitors.

In an embodiment, the organic solvent may be polycarbonate (PC), sulfonate, dimethyl sulfonate, ethylene carbonate (EC), acetonitrile (AN), N-methyl-2-pyrrolidone (NMP) or a combination thereof.

In addition, depending on actual needs, the electrolyte of the present embodiment may also include a wetting agent. When the electrolyte containing the wetting agent is applied to the capacitor, the wetting agent not only may effectively improve the wettability and flame retardancy of the separator in the capacitor, but also is less likely to participate in decomposition reaction.

In an embodiment, the wetting agent may be tris(2-ethylhexyl) phosphate. Based on the total weight of the electrolyte, the content of the wetting agent is between 0.01 wt % and 5 wt %. When the content of the wetting agent is higher than 5 wt %, the high-rate charge storage capacity of the electrical double layer capacitor will be affected. When the content of the wetting agent is less than 0.01 wt %, the wettability of the separator in the capacitor will be insufficient which in turn may affect the charge storage efficiency of the electrical double layer capacitor.

The bimolecular block polymer of the present disclosure and the electrolyte and the electrical double layer capacitor containing the bimolecular block polymer are described below with Experimental Examples and Comparative Examples.

### Synthesis Example 1

First, N-(2-hydroxyethyl)maleimide as the first compound of the present disclosure was dissolved in PC to form a mixed solution. Next, benzotriazole as the second compound of the present disclosure was added to the mixed solution. In the mixed solution, the total content of N-(2-hydroxyethyl)maleimide and benzotriazole was 5 wt %, and the molar ratio was 5:1. Then, a thermal polymerization was performed at 110° C. for 12 hours. As a result, the bimolecular block polymer of Synthesis Example 1 was obtained.

The bimolecular block polymers of Synthesis Examples 2 to 14 were obtained by using the same steps as in Synthesis Example 1, and the detailed polymerization conditions are shown in Table 1.

TABLE 1

| | bimolecular block polymer | | | | | | GPC peak |
|---|---|---|---|---|---|---|---|
| Synthesis | first | second | molar | | solute | reaction | of retention |
| Example | compound | compound | ratio | solvent | (wt %) | conditions | time (min) |
| 1 | A-1 | B-1 | 5:1 | PC | 5 | 110° C. | 32 |
| | | | | | | 12 hrs | |
| 2 | A-2 | B-1 | 2:1 | PC | 5 | 110° C. | 32 |
| | | | | | | 12 hrs | |
| 3 | A-3 | B-1 | 1:1 | PC | 5 | 110° C. | 32 |
| | | | | | | 12 hrs | |
| 4 | A-4 | B-1 | 1:5 | PC | 5 | 110° C. | 32 |
| | | | | | | 12 hrs | |
| 5 | A-1 | B-5 | 5:1 | PC | 5 | 110° C. | 31 |
| | | | | | | 12 hrs | |
| 6 | A-2 | B-2 | 2:1 | PC | 5 | 110° C. | 31 |
| | | | | | | 12 hrs | |
| 7 | A-3 | B-2 | 1:1 | PC | 5 | 110° C. | 31 |
| | | | | | | 12 hrs | |
| 8 | A-4 | B-2 | 1:5 | PC | 5 | 110° C. | 31 |
| | | | | | | 12 hrs | |
| 9 | A-1 | B-3 | 2:1 | PC | 5 | 100° C. | 30 |
| | | | | | | 12 hrs | |
| 10 | A-2 | B-3 | 1:1 | PC | 5 | 110° C. | 30 |
| | | | | | | 12 hrs | |
| 11 | A-3 | B-3 | 2:1 | PC | 5 | 110° C. | 30 |
| | | | | | | 12 hrs | |
| 12 | A-4 | B-3 | 2:1 | PC | 5 | 110° C. | 29 |
| | | | | | | 12 hrs | |
| 13 | A-4 | B-4 | 2:1 | PC | 5 | 110° C. | 29 |
| | | | | | | 12 hrs | |
| 14 | A-4 | B-5 | 2:1 | PC | 5 | 110° C. | 29 |
| | | | | | | 12 hrs | |

The molecular weight of the bimolecular block polymers were measured by JASCO PU-2080 Plus Gel permeation chromatography (GPC), which is equipped with a pump (JASCO PU-2080 Isocratic HPLC), an absorbance detector (RI-2031 plus), and Shodex KD-800 series (KD801, KD802.5, KD804, KD805) standard organic solvent SEC (GPC) columns.

According to the results obtained through gel permeation chromatography, the GPC peak of retention time of the first compound of Synthesis Example 1 was approximately at 45 minute, and the GPC peak of retention time of the second compound was approximately 46 minute. The GPC peak of retention time of the polymerized bimolecular block polymer was approximately at 32 minute, and there was no significant peak of retention time subsequently observed, indicating that the polymerization reaction was complete.

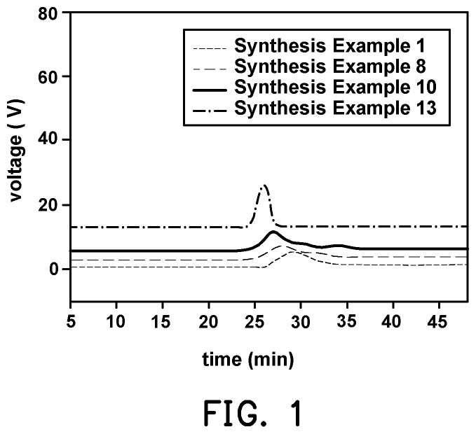

Moreover, as the molecular weight of the bimolecular block polymer increased, the GPC peak of retention time gradually decreased. FIG. 1 is the GPC curve of the bimolecular block polymers of Synthesis Example 1, Synthesis Example 8, Synthesis Example 10 and Synthesis Example 13, wherein the vertical axis indicated the signal intensity (sensitivity) obtained by the detector, and the horizontal axis indicated time. As shown in FIG. 1, Synthesis Example 1, Synthesis Example 8, Synthesis Example 10 and Synthesis Example 13 were taken as examples, it was found that Synthesis Example 1 had the longest GPC peak of retention time, and Synthesis Example 13 had the shortest GPC peak of retention time.

Further, in each of the above Synthesis Examples, no significant peak of retention time was observed starting from approximately 29 minute to the 32 minute, indicating that the polymerization reaction was complete.

### Experimental Example 1

PC was used as an organic solvent, and a quaternary ammonium salt SBPBF4, the bimolecular block polymer of Synthesis Example 14 and tris(2-ethylhexyl) phosphate as a wetting agent were added to prepare an electrolyte, wherein the concentration of SBPBF4 was 1.5 M, the content of the bimolecular block polymer was 0.5 wt %, and the content of the wetting agent was 1 wt %.

The prepared electrolyte was used as the electrolyte of a capacitor. The capacitor was an electrical double layer capacitor, wherein the anode and the cathode disposed opposite to each other were both aluminum electrodes, with a separator (Celgard 2320) disposed in-between.

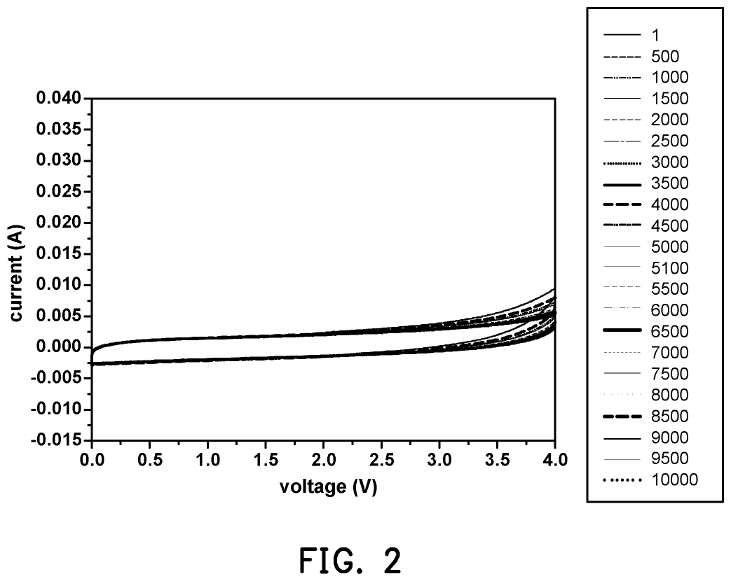

The durability test was performed on the capacitor, wherein the measuring potential window was 4 V, and the scanning rate was 10 mv/s. The C-V curve obtained from the durability test of the capacitor was shown in FIG. 2.

### Experimental Example 2

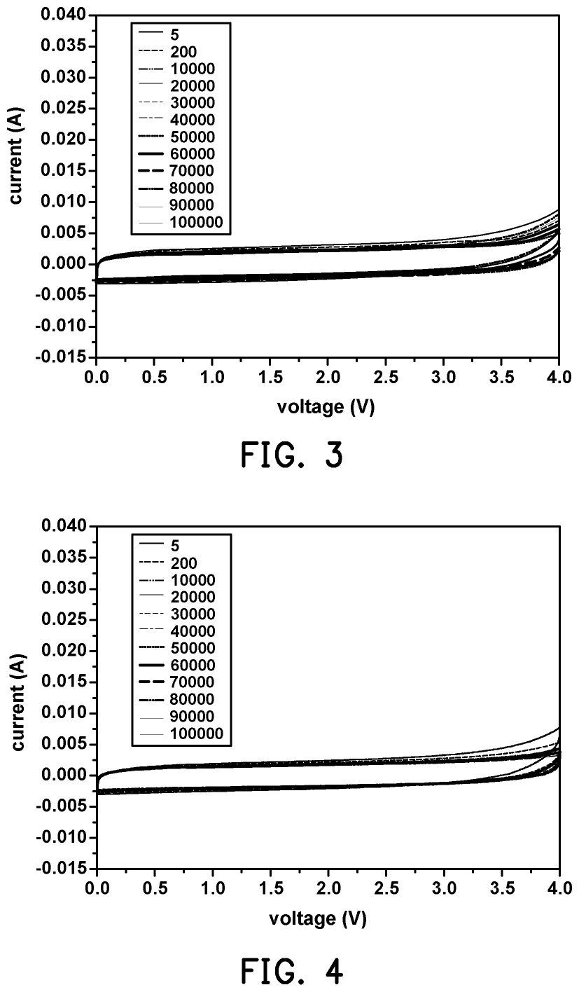

The electrolyte was obtained using the same preparation conditions as that of Experimental Example 1, except that the bimolecular block polymer of Synthesis Example 1 was substituted with the bimolecular block polymer of Synthesis Example 14, wherein the structure of the capacitor was the same as that of Experimental Example 1. The C-V curve obtained from the durability test of the capacitor was shown in FIG. 3.

### Experimental Example 3

The electrolyte was obtained using the same preparation conditions as that of Experimental Example 1, except that the quaternary ammonium salts SBPBF4 (1 M) and TEABF4 (0.5 M) were adopted, wherein the structure of the capacitor was the same as that of Experimental Example 1. The C-V curve obtained from the durability test of the capacitor was shown in FIG. 4.

### Experimental Example 4

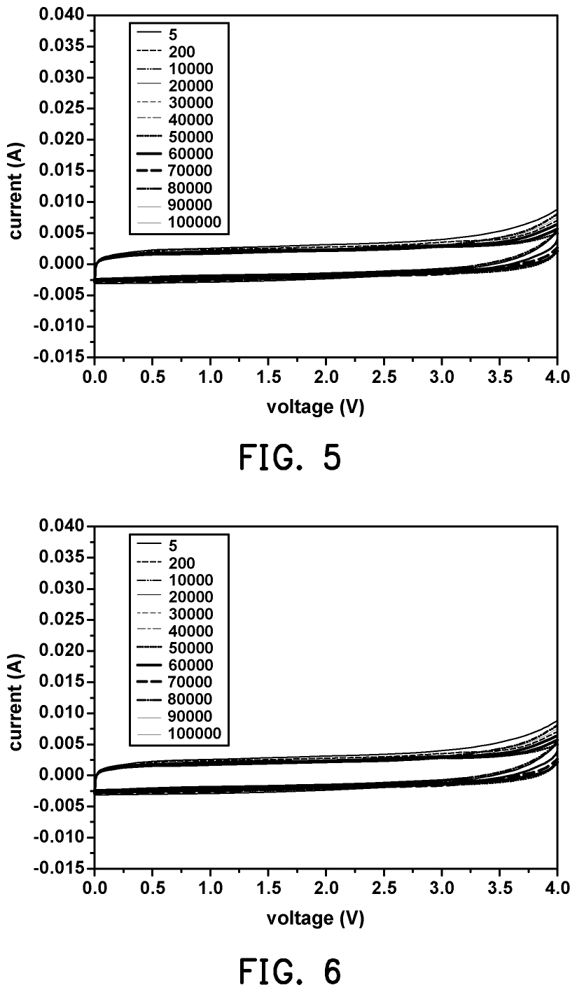

The electrolyte was obtained using the same preparation conditions as that of Experimental Example 1, except that the bimolecular block polymer of Synthesis Example 4 was substituted with the bimolecular block polymer of Synthesis Example 14 and the quaternary ammonium salts SBPBF4 (1 M) and TEABF4 (0.5 M) were adopted, wherein the structure of the capacitor was the same as that of Experimental Example 1. The C-V curve obtained from the durability test of the capacitor was shown in FIG. 5.

### Experimental Example 5

The electrolyte was obtained using the same preparation conditions as that of Experimental Example 1, except that the bimolecular block polymer of Synthesis Example 13 was substituted with the bimolecular block polymer of Synthesis Example 14, wherein the structure of the capacitor was the same as that of Experimental Example 1. The C-V curve obtained from the durability test of the capacitor was shown in FIG. 6.

### Experimental Example 6

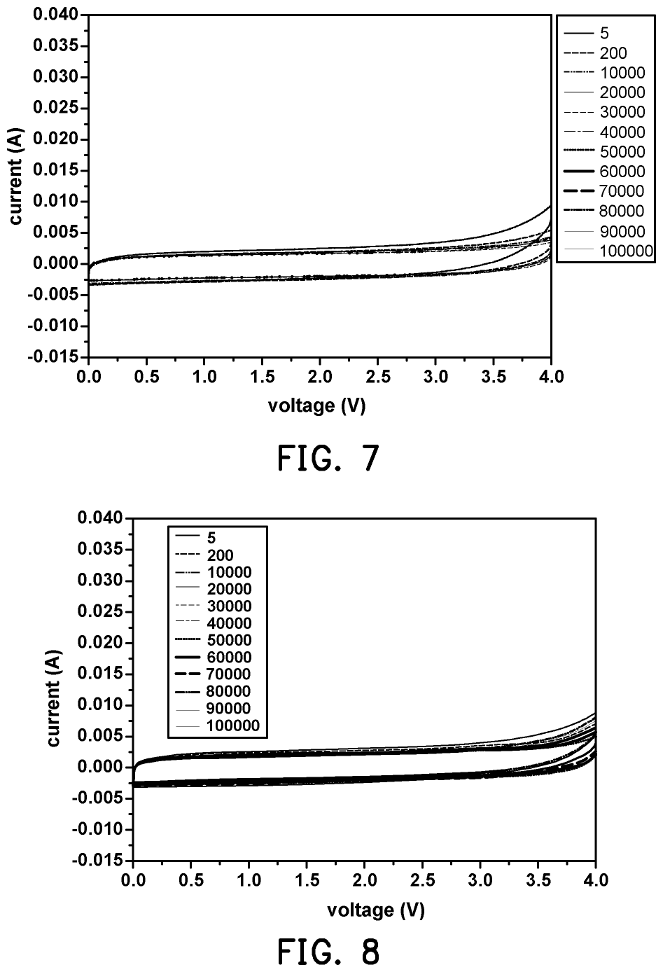

The electrolyte was obtained using the same preparation conditions as that of Experimental Example 1, except that the bimolecular block polymer of Synthesis Example 5 was substituted with the bimolecular block polymer of Synthesis Example 14 and the content of the bimolecular block polymer in the electrolyte was 0.1 wt %, wherein the structure of the capacitor was the same as that of Experimental Example 1. The C-V curve obtained from the durability test of the capacitor was shown in FIG. 7.

### Experimental Example 7

The electrolyte was obtained using the same preparation conditions as that of Experimental Example 1, except that the bimolecular block polymer of Synthesis Example 13 was substituted with the bimolecular block polymer of Synthesis Example 14 and the quaternary ammonium salts SBPBF4 (1 M) and TEABF4 (0.5 M) were adopted, and that the content of the bimolecular block polymer in the electrolyte was 0.1 wt %, wherein the structure of the capacitor was the same as that of Experimental Example 1. The C-V curve obtained from the durability test of the capacitor was shown in FIG. 8.

### Comparative Example 1

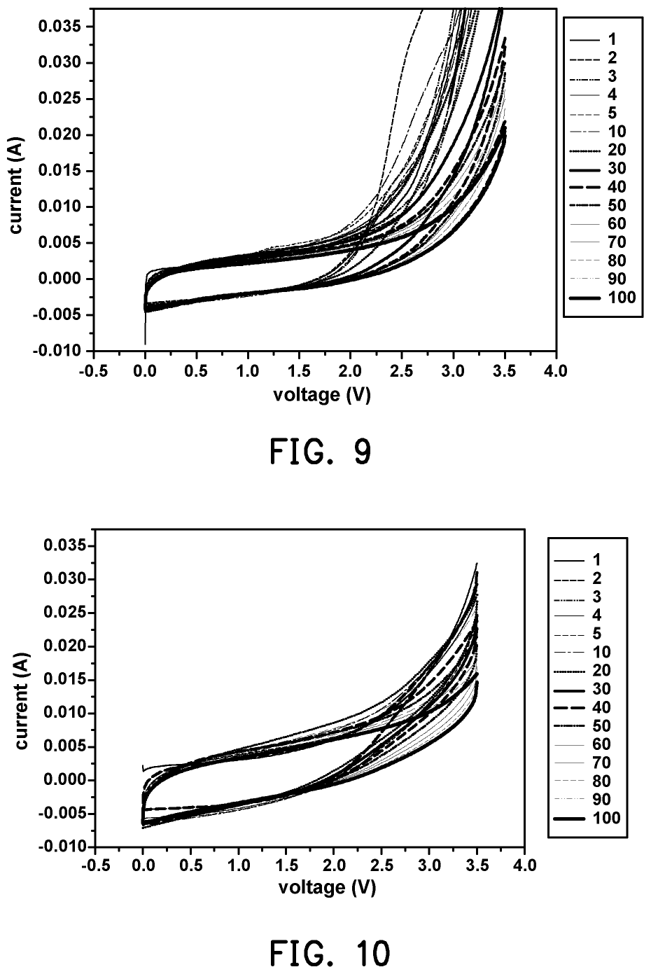

The electrolyte was obtained using the same preparation conditions as that of Experimental Example 1, except that the electrolyte contained only TEABF4 (1 M) and AN, the separator in the capacitor was a cellulose film and the measuring potential window was 3.5 V. The C-V curve obtained from the durability test of the capacitor was shown in FIG. 9.

### Comparative Example 2

The electrolyte was obtained using the same preparation conditions as that of Comparative Example 1, except that the electrolyte contained only TEMABF4 (1.8 M) and AN. The C-V curve obtained from the durability test of the capacitor was shown in FIG. 10.

### Comparative Example 3

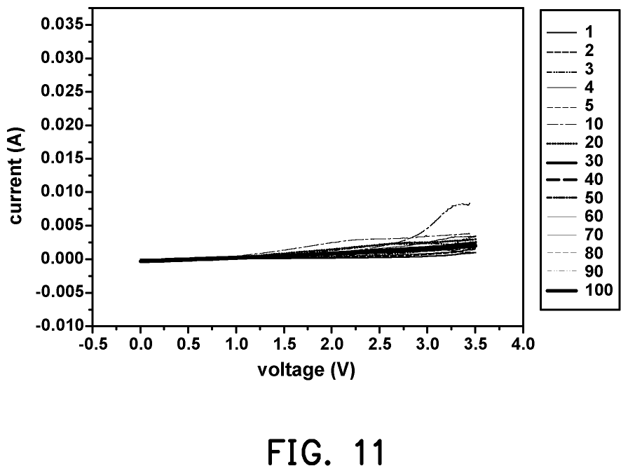

The electrolyte was obtained using the same preparation conditions as that of Comparative Example 1, except that the electrolyte contained only DMPBF4 (1 M) and AN. The C-V curve obtained from the durability test of the capacitor was shown in FIG. 11.

### Comparative Example 4

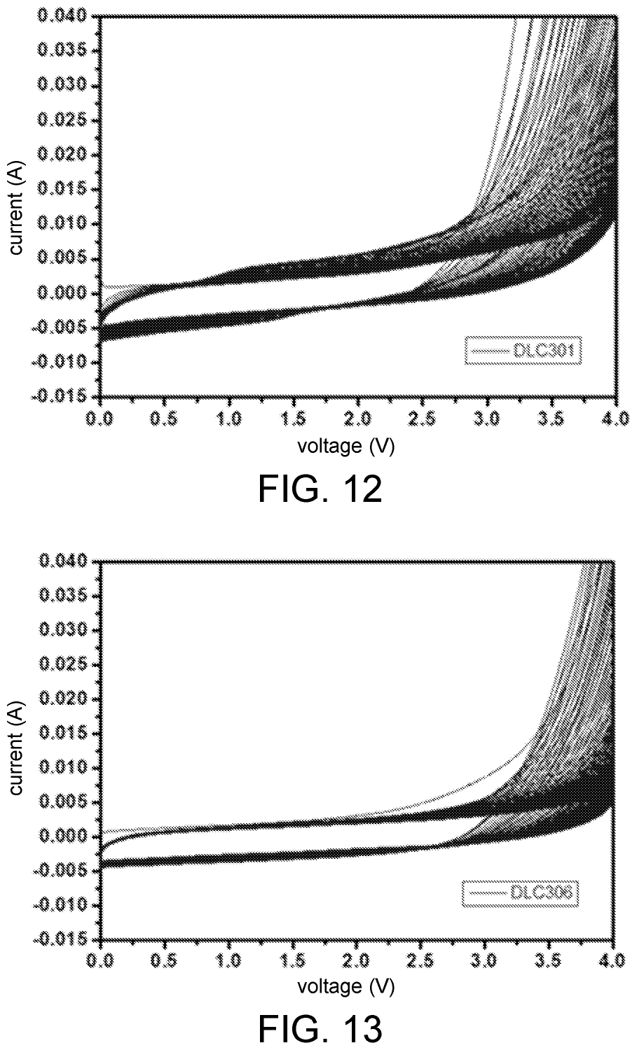

The electrolyte was obtained using the same preparation conditions as that of Comparative Example 1, except that the measuring potential window was 4.0 V. The C-V curve obtained from the durability test of the capacitor was shown in FIG. 12.

### Comparative Example 5

The electrolyte was obtained using the same preparation conditions as that of Comparative Example 2, except that the measuring potential window was 4.0 V. The C-V curve obtained from the durability test of the capacitor was shown in FIG. 13.

### Comparative Example 6

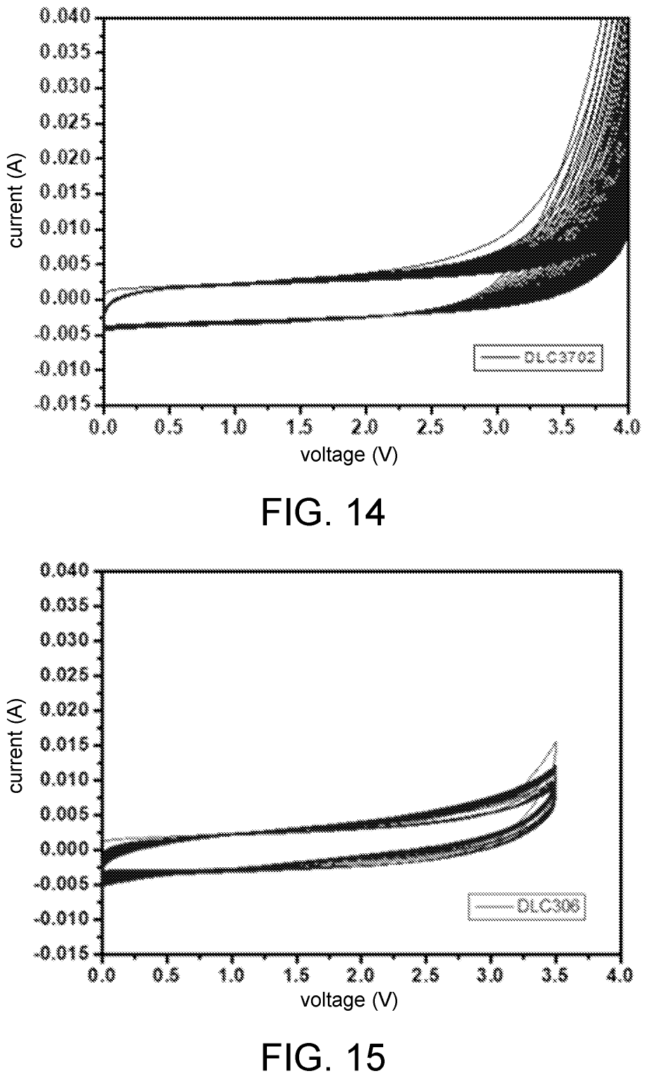

The electrolyte was obtained using the same preparation conditions as that of Comparative Example 3, except that the measuring potential window was 4.0 V. The C-V curve obtained from the durability test of the capacitor was shown in FIG. 14.

### Comparative Example 7

The electrolyte was obtained using the same preparation conditions as that of Comparative Example 2, except that the separator in the capacitor was Celgard 2320 separator. The C-V curve obtained from the durability test of the capacitor was shown in FIG. 15.

### Comparative Example 8

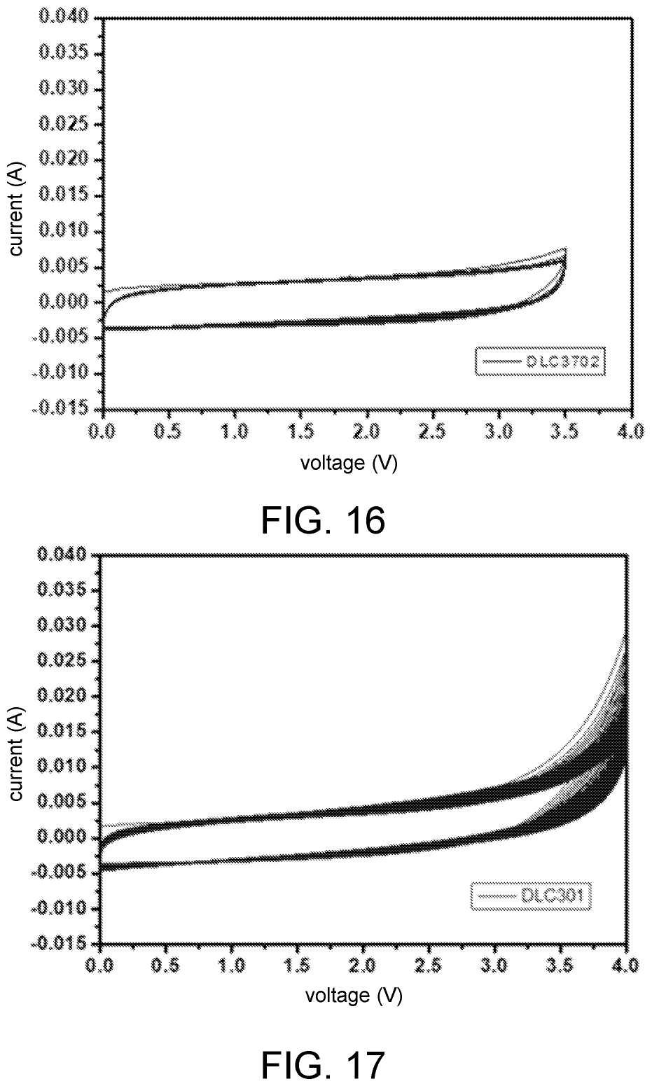

The electrolyte was obtained using the same preparation conditions as that of Comparative Example 3, except that the separator in the capacitor was Celgard 2320 separator. The C-V curve obtained from the durability test of the capacitor was shown in FIG. 16.

### Comparative Example 9

The electrolyte was obtained using the same preparation conditions as that o Comparative Example 1, except that the separator in the capacitor was Celgard 2320 separator and the measuring potential window was 4.0 V. The C-V curve obtained from the durability test of the capacitor was shown in FIG. 17.

### Comparative Example 10

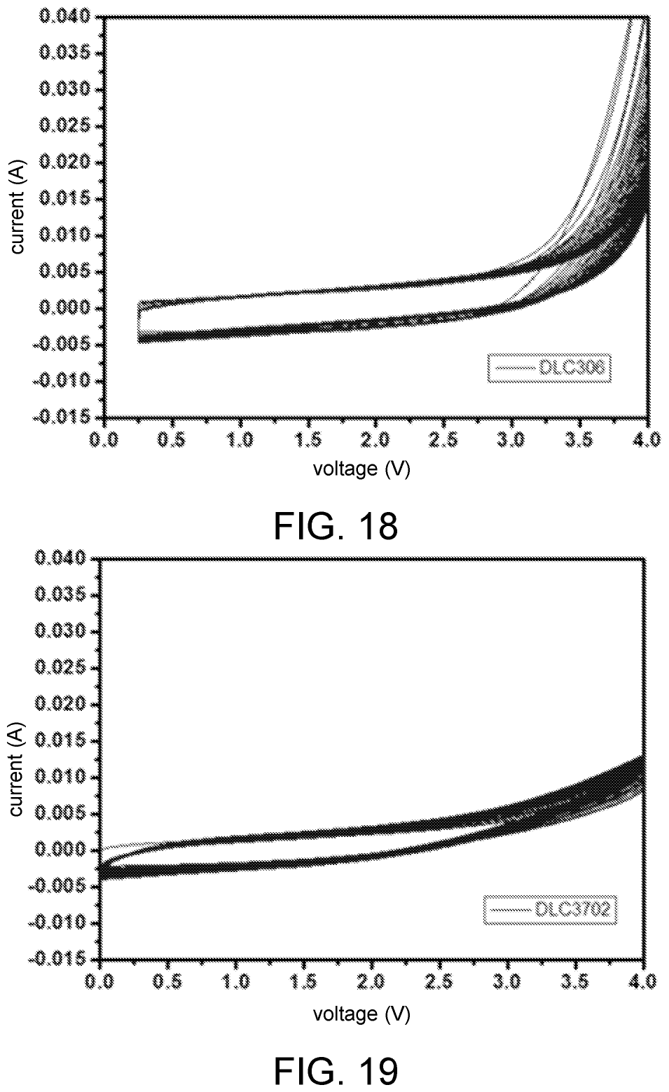

The electrolyte was obtained using the same preparation conditions as that o Comparative Example 2, except that the separator in the capacitor was Celgard 2320 separator and the measuring potential window was 4.0 V. The C-V curve obtained from the durability test of the capacitor was shown in FIG. 18.

### Comparative Example 11

The electrolyte was obtained using the same preparation conditions as that of Comparative Example 3, except that the separator in the capacitor was Celgard 2320 separator and the measuring potential window was 4.0 V. The C-V curve obtained from the durability test of the capacitor was shown in FIG. 19.

### Comparative Example 12

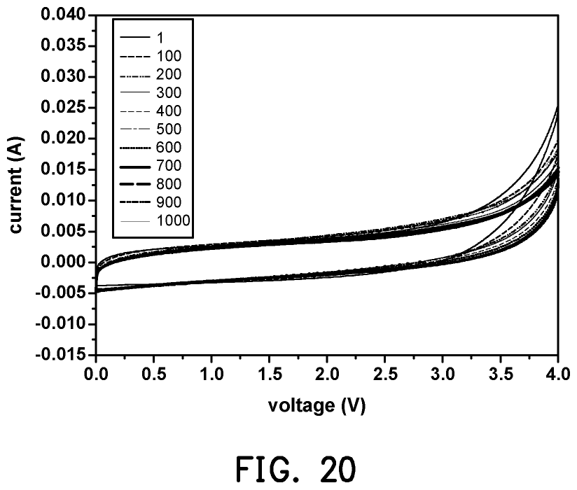

The electrolyte was obtained using the same preparation conditions as that of Comparative Example 3, except that the separator in the capacitor was Celgard 2320 separator and the measuring potential window was 4.0 V. The C-V curve obtained from the durability test of the capacitor was shown in FIG. 20.

### Comparative Example 13

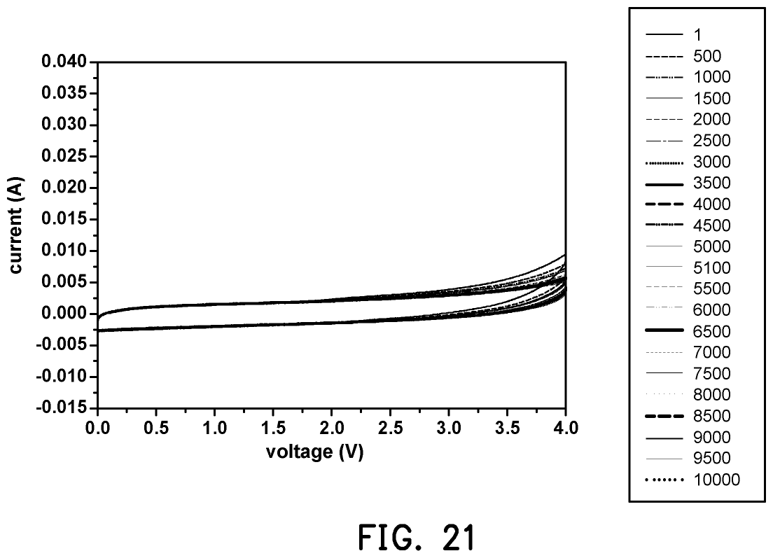

The electrolyte was obtained using the same preparation conditions as that of Experimental Example 1, except that the electrolyte contained only SBPBF4 (1.5 M) and PC and the measuring potential window was 4.0 V. The C-V curve obtained from the durability test of the capacitor was shown in FIG. 21.

The durability test results of the capacitors of Experimental Examples 1 to 7 and Comparative Example 1 to 13 were shown in Table 2 below.

TABLE 2

| | measuring potential | real potential | |
|---|---|---|---|
| | window (V) | window (V) | cycles |
| Experimental Example 1 | 4.0 | 4.0 | 100000 |
| Experimental Example 2 | 4.0 | 4.0 | 100000 |
| Experimental Example 3 | 4.0 | 4.0 | 100000 |
| Experimental Example 4 | 4.0 | 4.0 | 100000 |
| Experimental Example 5 | 4.0 | 4.0 | 100000 |
| Experimental Example 6 | 4.0 | 4.0 | 100000 |
| Experimental Example 7 | 4.0 | 4.0 | 100000 |
| Comparative Example 1 | 3.5 | 2.2 | 100 |
| Comparative Example 2 | 3.5 | 2.5 | 100 |
| Comparative Example 3 | 3.5 | 3.2 | 100 |
| Comparative Example 4 | 4.0 | 2.5 | 100 |
| Comparative Example 5 | 4.0 | 3.0 | 100 |
| Comparative Example 6 | 4.0 | 3.2 | 100 |
| Comparative Example 7 | 3.5 | 3.3 | 100 |
| Comparative Example 8 | 3.5 | 3.5 | 100 |
| Comparative Example 9 | 4.0 | 3.3 | 100 |
| Comparative Example 10 | 4.0 | 3.3 | 100 |
| Comparative Example 11 | 4.0 | 3.3 | 100 |
| Comparative Example 12 | 4.0 | 3.3 | 1000 |
| Comparative Example 13 | 4.0 | 3.7 | 10000 |

In Experimental Examples 1 to 7, since the electrolyte contains the bimolecular block polymer of the present disclosure, the capacitor may withstand a higher operating voltage (4.0 V) and may have a wide electrochemical stability window, as can be seen in Table 2 and FIGS. 2 to 21. As a result, the reliability of the capacitor may be improved, so that the cycle life of the capacitor may reach over 12,000 cycles.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A bimolecular block polymer, suitable for an electrolyte of a capacitor, and formed by polymerizing a first compound and a second compound, wherein the first compound is represented by one of formula (A-1) to formula (A-4), the second compound is represented by one of formula (B-1) to formula (B-5), and a molar ratio of the first compound to the second compound is between 5:1 and 1:5,

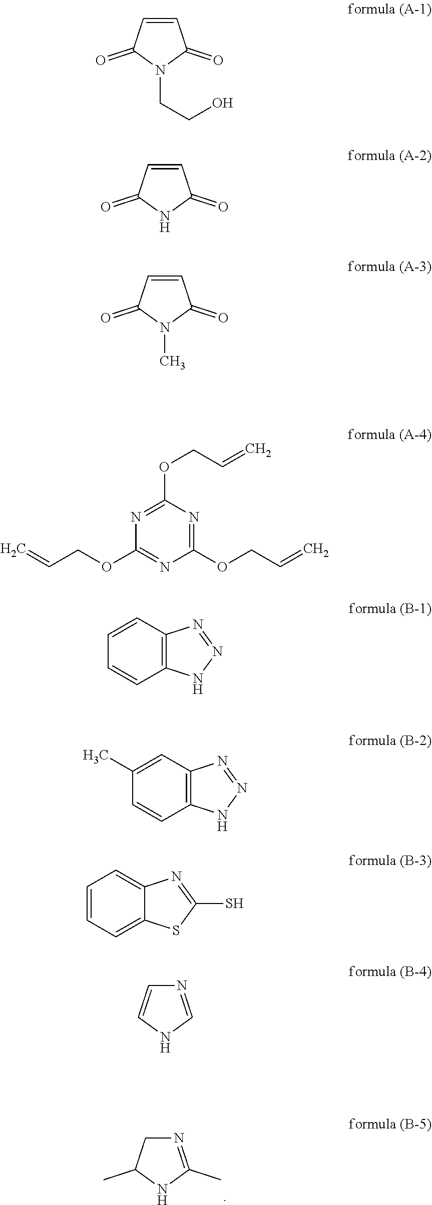

2. The bimolecular block polymer of claim 1, wherein the molar ratio of the first compound to the second compound is between 1:1 and 2:1.

3. The bimolecular block polymer of claim 1, wherein the bimolecular block polymer has a molecular weight between 10,000 and 200,000.

4. The bimolecular block polymer of claim 1, wherein the capacitor comprises an electrical double layer capacitor.

5. An electrolyte, suitable for a capacitor, comprising:
a quaternary ammonium salt;
a bimolecular block polymer; and
a residual amount of an organic solvent,
wherein a content of the quaternary ammonium salt is between 0.5 M and 2.0 M, and a content of the bimolecular block polymer is between 0.01 wt % and 5 wt %, based on the total weight of the electrolyte, and wherein the bimolecular block polymer is formed by polymerizing a first compound and a second compound, the first compound is represented by one of formula (A-1) to formula (A-4), the second compound is represented by one of formula (B-1) to formula (B-5), and a molar ratio of the first compound to the second compound is between 5:1 and 1:5,

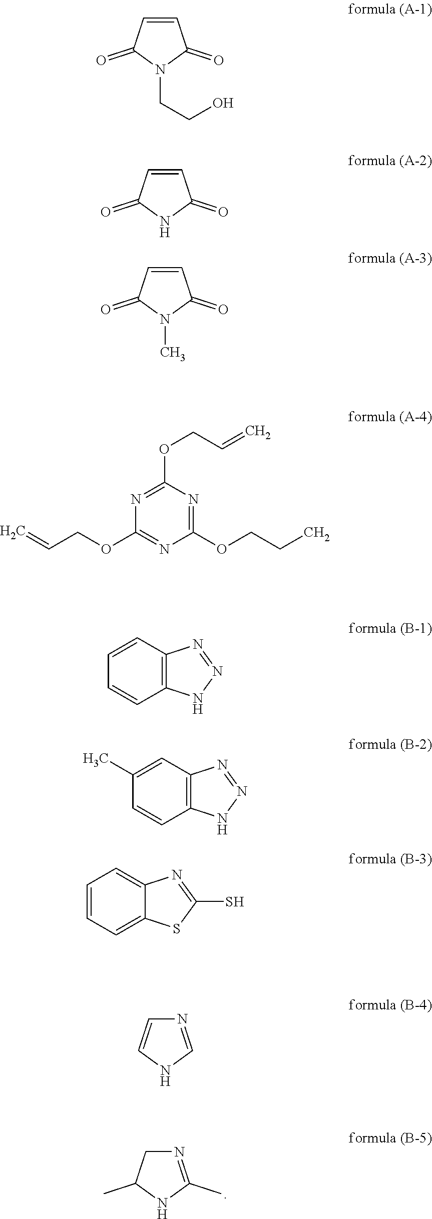

6. The electrolyte of claim 5, wherein a molar ratio of the first compound to the second compound is between 1:1 and 2:1.

7. The electrolyte of claim 5, wherein the bimolecular block polymer has a molecular weight between 10,000 and 200,000.

8. The electrolyte of claim 5, wherein the quaternary ammonium salt comprises spirodipyrrolidinium tetrafluoroborate, dimethylpyrrolidinium tetrafluoroborate, tetraethylammonium tetrafluoborate, triethylmethylammoniumtetrafluoroborate or combinations thereof.

9. The electrolyte of claim 5, wherein the organic solvent comprises polycarbonate, sulfonate, dimethyl sulfonate, ethylene carbonate, acetonitrile, N-methyl-2-pyrrolidone or a combination thereof.

10. The electrolyte of claim 5, further comprising a wetting agent.

11. The electrolyte of claim 10, wherein the wetting agent comprises tris(2-ethylhexyl) phosphate.

12. The electrolyte of claim 10, wherein, a content of the wetting agent is between 0.01 wt % and 5 wt % based on the total weight of the electrolyte.

13. The electrolyte of claim 5, wherein the capacitor comprises an electrical double layer capacitor.

14. An electrical double layer capacitor, comprises:
an anode and a cathode, disposed opposite to each other;
a separator, disposed between the anode and the cathode; and
the electrolyte of claim 5.
